(19) United States
(12) Patent Application Publication
(10) Pub. No.: US 2009/0106135 A1
(43) Pub. Date: Apr. 23, 2009

(54) HOME WARRANTY METHOD AND SYSTEM

(76) Inventor: Robert James Steiger, Linwood, NJ (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/875,607

(22) Filed: Oct. 19, 2007

(51) Int. Cl. G06Q 40/00; G06Q 30/00

(52) U.S. Cl. 705/35; 705/1

(57) ABSTRACT

A method of selling a home includes entering into a contract with a buyer to sell a newly constructed home to the buyer, and entering into a warranty agreement with the buyer. The warranty agreement warrants a majority of the components of the newly constructed home for a time period from the date of the contract, requires the buyer to comply with a maintenance schedule to be verified by periodic inspection, and conditions at least a portion of the warranty on the buyer's compliance with the maintenance schedule. The method may include collecting a transaction cost from the buyer, where the transaction cost includes a cost for the home and a cost for the warranty.

### RELATED APPLICATION AND CLAIM OF PRIORITY

This patent application claims priority to U.S. provisional patent application No. 60/682,089, filed Oct. 19, 2006.

### BACKGROUND

The purchase of a new home can be the largest investment that an individual or family will make in their lifetime. Many home buyers seek newly constructed homes because such homes may: (i) retain their value longer; (ii) allow the buyer to customize the home based on the buyer's desires; and (iii) require a lower level of maintenance during the first years of ownership. An individual or family often seeks a home as a foundation for their long term investment for retirement.

Unfortunately, the quality of construction in recent years has deteriorated, and thus the concept of purchasing a home as a long term investment does not always hold true. Due to poor construction, homes may stagnate or lose value as they become older. The quality of construction has been driven down by many factors. These include increasing material costs, smaller profit margins on materials, shortages of skilled workers in some locations, and buyer demand for low prices. The drive to reduce costs has caused many manufacturers of building materials, such as windows, roofing materials, mechanical systems and other elements, to produce inferior products. This makes it more difficult for many builders to provide a well-constructed home.

It is desirable to find new ways to construct, sell and service a newly constructed home that may help the home maintain its value over the buyer's lifetime. The disclosure contained herein is directed toward solving some or all of the problems described above.

### SUMMARY

In an embodiment, a method of selling a home includes entering into a contract with a buyer to sell a newly constructed home to the buyer and entering into a warranty agreement with the buyer. The warranty agreement warrants a majority of the components of the newly constructed home for a time period of at least 25 years from the date of the contract, requires the buyer to comply with a maintenance schedule to be verified by periodic inspection, and conditions at least a portion of the warranty on the buyer's compliance with the maintenance schedule. The method may include collecting a transaction cost from the buyer, where the transaction cost includes a cost for the home and a cost for the warranty.

Optionally, the warranty agreement includes a term requiring the buyer to obtain pre-approval for listed modifications to the home, and failure by the buyer to obtain the pre-approval any of the listed modifications will void at least a portion of the warranty's coverage. The warranty agreement also may include a term requiring the buyer to use a designated warranty service provider for listed repairs of certain components of the home, and failure by the buyer to use the designated warranty service provider for any of the listed repairs will void the warranty. Optionally, the method may include constructing the home with a durable material, and contracting with a supplier of the durable material to provide a warranty having a duration that equals or exceeds the period of the home warranty agreement.

In some embodiments, the method also may include automatically determining a warranty cost by using a computing device to access a database of projected maintenance costs for various home values, wherein each cost in the database is associated with various home specifications. The computing device may compare specifications for the newly constructed home to the specifications in the database to determine a total projected maintenance cost over the time period, and establishing the warranty cost based on the total projected maintenance cost. Optionally, the warranty cost is established by multiplying the total projected maintenance cost by a predetermined scaling factor. In some embodiments, the method may include receiving the warranty cost from the buyer, and placing the warranty cost in a reserve account.

Optionally, the method may include (i) receiving a service call from the buyer, wherein the service call requests service on a component of the home, (ii) accessing a database of component warranties to determine whether the component is the subject of a warranty from a third party supplier warranty, and (iii) if the component is the subject of a warranty from a third party supplier, directing the supplier to provide a service corresponding to the service call. Alternatively, the method may include receiving a service call from the buyer, wherein the service call requests service on a component of the home, (ii) determining whether the component is the subject of a warranty from a third party supplier warranty, and (iii) if the component is not the subject of a warranty from a third party supplier, performing a service corresponding to the service call. As yet another alternative, the method may include (i) receiving a service call from the buyer, wherein the service call requests service on a component of the home, (ii) determining whether the component is the subject of a warranty from a third party supplier warranty; and (iii) if the component is not the subject of a warranty from a third party supplier, performing a service corresponding to the service call, and receiving a payment for the service from the reserve account.

In an alternate embodiment, a method of selling a home includes accessing a database of projected maintenance costs for a plurality of home values, wherein each cost in the database is associated with a plurality of home specifications. The method may compare a plurality of specifications for a newly constructed home to the specifications in the database to determine a total projected maintenance cost over the time period. It may include establishing a warranty cost based on the total projected maintenance cost, entering into a contract with a buyer to sell the newly constructed home to the buyer, and entering into a warranty agreement with the buyer. The warranty agreement warrants a plurality of the components of the newly constructed home for a time period, requires the buyer to comply with a maintenance schedule to be verified by periodic inspection, and conditions at least a portion of the warranty on the buyer's compliance with the maintenance schedule. The method also may include collecting a transaction cost from the buyer, the transaction cost comprising a cost for the home and the warranty cost.

### BRIEF DESCRIPTION OF THE DRAWINGS

FIG. 1 is a diagram showing various entities that may work together in connection with the service and sale of a newly constructed home.

FIG. 2 is a process flow diagram showing exemplary steps of a method of selling and warranting a newly constructed home.

FIG. 3 is a diagram showing exemplary elements of a new home warranty in accordance with various embodiments described herein.

FIG. 4 is a block diagram showing exemplary elements of a computer system that may bee used to implement some or all of the methods described in this document.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

In accordance with embodiments described herein, a newly constructed home is sold with a lifetime warranty covering a majority of the components of a newly constructed home. As used herein, the term “lifetime” may mean a time period less than, equal to or exceeding the average expected life span of a home buyer. For example, in some embodiments a lifetime warranty may be provided for 50 years, and in other embodiments a lifetime warranty may be provided for 99 years. In other embodiments, a lifetime warranty may be provided for any time period between 25 years and 99 years, or even for a time period that exceeds 99 years.

In embodiments described herein, the warranty protects against defects in material or workmanship relating to a majority of the components provided with the newly constructed home. For example, the warranty may cover required repair and/or replacement of any of the following items: roofing, siding, windows, flooring, kitchen, doors, structural issues of defects, plumbing systems, air conditioning systems, electrical systems, heating systems, water heaters, appliances, duct work, garage doors, garage door openers, sump pumps, central vacuum systems, ventilation systems, garbage disposals, toilets, lights and even light bulbs.

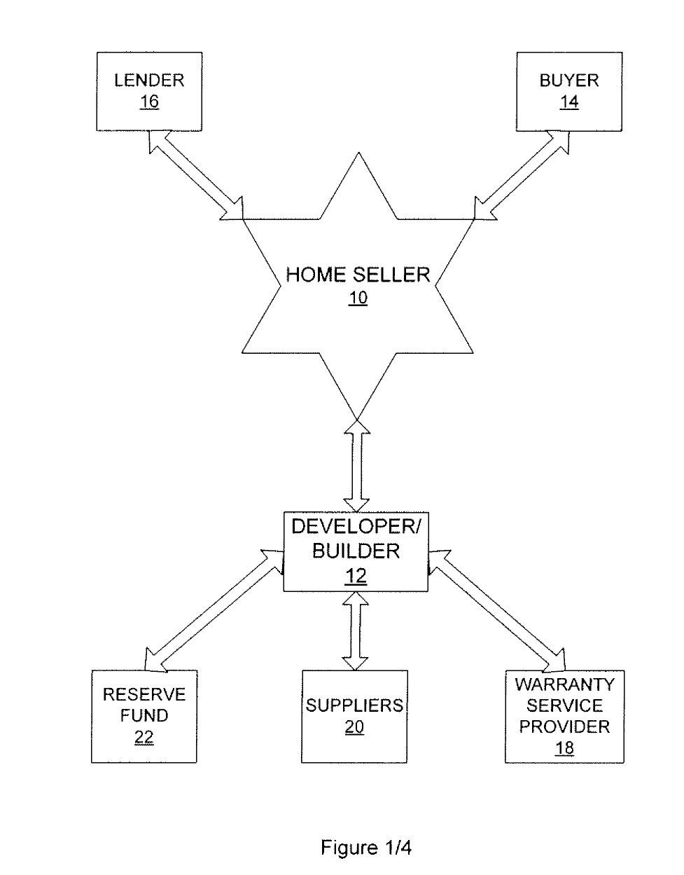

In embodiments described herein, a lifetime warranty is provided to a home buyer as part of the transaction for the sale of a home. Referring to FIG. 1, a home seller 10 may sell a newly constructed home to a home buyer 14, and the sales agreement documents will include a warranty contract, along with other documents such as a deed and/or a construction agreement. The warranty contract may be between the developer/builder and the buyer, or between a warranty service provider and the buyer.

The selling price of the home may include the cost of a lifetime warranty. In alternate embodiments, the cost of a lifetime warranty may be separate from the cost of the home. However, it is preferred that the lifetime warranty be included in the selling price so that the home buyer 14 can pay for the warranty out of funds obtained from a lender 16 through a mortgage or other loan process. The lender 16 may provide the money to the home seller 10, or the home buyer 14 may provide the money directly to the home seller 10.

Home seller 10 provides the home to the home buyer with documentation describing terms and conditions of a lifetime warranty provided by the developer or builder 12. In some embodiments, the developer/builder 12 and the home seller 10 may be the same entity. In other embodiments, the developer/builder 12 and home seller 10 may be different entities. The developer/builder 12 may contract with a warranty service provider 18 to provide warranty service to the home buyer 14. In some embodiments, some repairs such as structural repairs that occur during an initial post-construction period, such as the first three years after construction, or expected repairs due to settling such as wall cracks and floor creeks, may be repaired by the developer/builder 12 itself or through its contractors without contracting with the warranty service provider 18. In other embodiments the developer/builder 12 may contract with the warranty service provider for all repairs. In some embodiments, the homeowner may be required to use the developer/builder 12 or the designated service provider 18 for any or all repairs.

The developer/builder 12 also may have a relationship with a reserve holding entity 22, such as a bank, investment fund or other entity that can hold the amount of the home selling price that was allocated to warranty coverage so that the warranty payment amount can grow through interest or investment over the time period of the lifetime warranty. In addition, the developer/builder 12 contracts with one or more suppliers 20 who supply home components for use in construction of the home. Some or all of the components also may contain lifetime warranties or similar warranties that cover some or all of the lifetime warranty period provided to the home buyer. The suppliers 20 may work with the warranty service provider 18 to provide warranty service during the time period of the lifetime warranty.

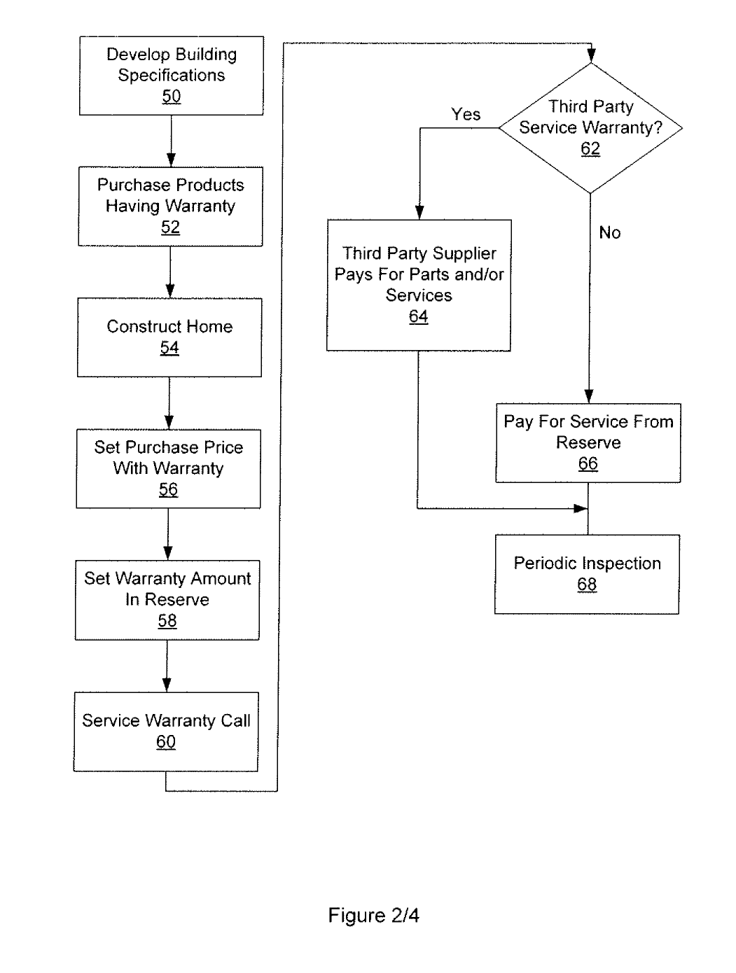

FIG. 2 illustrates an exemplary process of providing a lifetime warranty for a newly constructed home. Referring to FIG. 2, a developer or builder develops 50 building specifications for a newly constructed home. The specifications preferably include durable material options. When constructing the home 54, the developer may purchase 52 products from third-party suppliers, at least some of which may include warranties that equal or exceed the time period of the lifetime warranty that the developer provides to the home buyer. In some embodiments, it is preferable that third-party suppliers provide lifetime warranties for building materials selected from some or all of the following categories: roofing, siding, windows, flooring, kitchen materials such as cabinets and sinks, garage doors, countertops and doors. The warranties provided by these third-party service providers may include not only the supply of a replacement component, but also the installation of the replacement component. The developer may negotiate with third-party suppliers of such products to obtain lower per unit prices in exchange for higher volumes.

Once the specifications and material suppliers are identified, the home is constructed 54 and the developer, builder or seller establishes a purchase price 56 that includes the cost of a warranty. In some embodiments, the warranty price corresponds to a percentage of the purchase price of the home, such as five percent, ten percent, fifteen percent or any other appropriate percentage of the home selling price. In other embodiments, the warranty cost may be a fixed amount for multiple ranges of home prices. Calculation of the warranty cost may consider estimated costs for various expenses during various time periods. For example, the cost may consider items such as:
caulking of windows, tub areas, kitchen counters, sinks and toilets;
adjustment of interior and/or exterior doors;
heating, venting and air conditioning (HVAC) service and filter cleaning;
replacement of light bulbs;
repairing of buckled siding;
tile grouting;
carpet cleaning;
cleaning and lubricating window hardware;
miscellaneous repairs and adjustments to doors, kitchen cabinets, toilets, settlement repairs, decking, roofing, fireplace, siding, faucets, cleaning, soffits, appliances and/or HVAC;
roofing replacement;
window replacement;
appliance replacement;
exterior caulking;
flooring replacement;
painting;
kitchen cabinet replacement;
heating system replacement;
hot water heater replacement;
light fixture replacement; and
vanity and countertop replacement.

In some embodiments, calculation of the warranty cost may be performed automatically by establishing a baseline cost using a software program that receives the estimated maintenance and repair costs over a warranty period for some or all of the items listed above. The estimated cost may be entered into the system based on home features, home size, construction materials used, or other variables. Alternatively, the estimated costs may be retrieved from a database of estimated costs for homes having similar features, sizes and/or material qualities.

The warranty cost may be set at a level equal to the sum of some or all of the estimated costs for the repairs and replacements listed above. Alternatively it may be set at some level less than the estimated cost with the expectation that the builder will receive the warranty cost and obtain a return on investing the warranty cost in order to cover the additional maintenance and repair costs, plus receive a profit. Alternatively, the warranty cost may be set at a level that equals the sum of the estimated costs multiplied by a scaling factor so that the warranty cost is equal to or above the total projected maintenance costs.

After the home sale transaction is complete, the builder or seller receives funds from the buyer and may set aside 58 the warranty amount in a reserve account, investment fund or other appropriate place that preferably will bear interest or otherwise grow over time. The developer/builder also provides or establishes a relationship with a warranty service provider that will service the warranty during the lifetime warranty. When the warranty service provider receives a service call 60, the warranty service provider may determine whether the component that is the subject of the call has an applicable third-party supplier warranty 62. Some or all of these actions may be performed automatically by accessing a database of third party warranties for the home in question. If the component has a third-party supplier warranty, the service provider may obtain replacement components from the third-party supplier or require the third-party supplier to perform the service 64. In some embodiments, the third-party supplier may provide the replacement component and pay the warranty service provider for the service. Alternatively, if the component is not covered by a third-party warranty that is still in effect at the time of the service call, the warranty service provider may perform the service and receive funds for the service from either the reserve account or the developer 66. In some embodiments, the developer pays for some category of repairs, such as repairs within a post-construction period (such as three years), while other repairs are paid for from the reserve account. In addition, the service provider will perform or arrange for the performance of periodic inspections 68 to ensure that the home buyer has complied with the terms of the lifetime warranty.

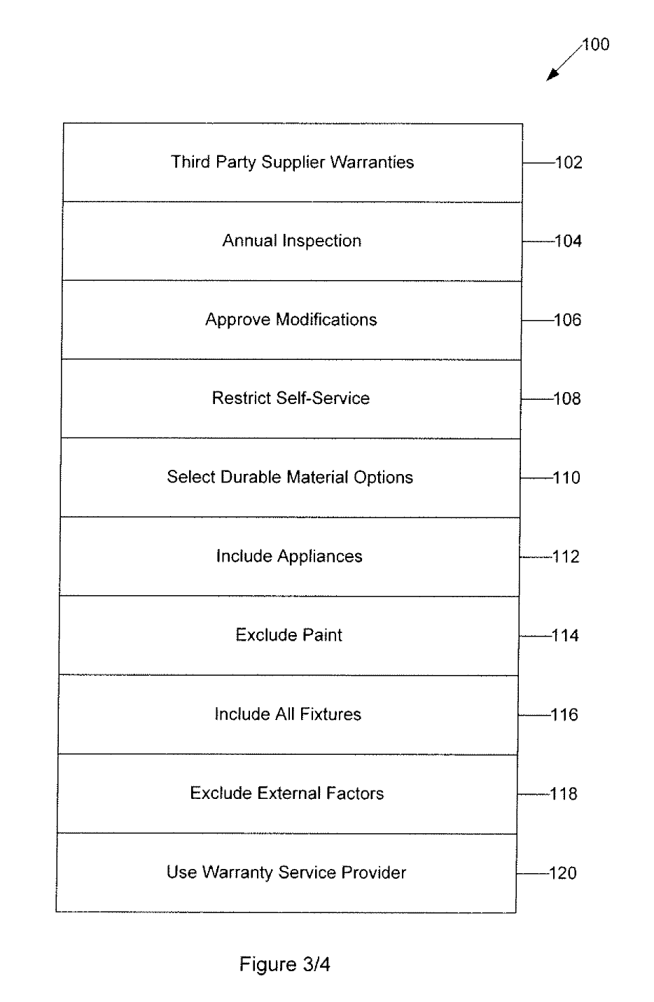

FIG. 3 illustrates exemplary terms and conditions that may be included in a lifetime warranty 100. For example, the lifetime warranty may pass along third-party supplier warranties 102 such as third-party compliance, garage door, roofing and/or other warranties. The warranty terms may also require the home buyer to agree to a periodic inspection 104 such as a bi-annual, annual or semi-annual inspection, provided by or arranged by the warranty service provider or developer to ensure that the home buyer has complied with the terms and conditions of the warranty. In some embodiments, the periodic inspection will be performed annually, although other time periods are possible.

For example, the warranty agreement may require the homeowner to adhere to a predetermined maintenance schedule for wear items, such as doors, windows and plumbing. The warranty agreement may require the home buyer to obtain developer or service provider approval of all modifications 106 to ensure that the modifications will not adversely affect the structural integrity of the home. If the home buyer makes modifications that are not approved or uses replacement components that are not approved by the developer or service provider, such actions may void the warranty. In addition, it is preferable that the home buyer be required to use the warranty service provider 120 for certain or all maintenance items, repairs or modifications. In some embodiments, the warranty may restrict self service of some or all repairs and/or additions 108, with the result being voiding of the warranty if the home buyer services the home himself rather than arranging for service through the warranty service provider. Alternatively, the warranty service provider may be required to pre-approve all modifications or repairs before they are made.

The maintenance schedule also may require the homeowner to perform certain routine maintenance activities at scheduled times. Examples may include furnace filter replacement, annual carpet cleaning, and annual gutter cleaning.

The warranty may require durable material options 110. For example, instead of carpeting, at least 50 percent, or in some embodiments at least 80 percent, of the flooring in the home may be uncarpeted. Carpet is a high wear material, and the elimination of carpet in favor of hardwood, ceramic tile or stone flooring may provide a much more durable surface and require less maintenance, than carpeted flooring. Other durable material options 110 may include the use of cast iron and copper plumbing in a majority, and preferably at least 70 percent, and more preferably at least 90 percent, of the plumbing pipe in the home. Preferably, plastic or PVC piping is not used at all, or it may not be used in more than five percent or ten percent of the home's piping, or it may be used only in venting systems. In some embodiments, floor joists and studs may be made of material that is less subject to warping and/or moisture damage, such as kiln dry wood.

In some embodiments, the warranty 100 may include some or all of the appliances 112 sold with the home. It is preferable that in such situations, the developer or seller obtain similar warranties from the appliance supplier.

In some embodiments, paint will be excluded from the warranty 114. However, all fixtures 115, such as light fixtures, electrical outlets and other electrical connections, and even light bulbs, may be included in some embodiments. However, external factors such as flood, fire, tornado, freeze/thaw cycles and other external factors may be excluded 118 from the warranty. In addition, in some embodiments, the warranties may exclude damage or wear caused by misuse and/or overuse of materials, which may be determined by periodic inspection of the property.

In some embodiments, the warranty provided with the sale may be transferable to subsequent purchasers of the home.

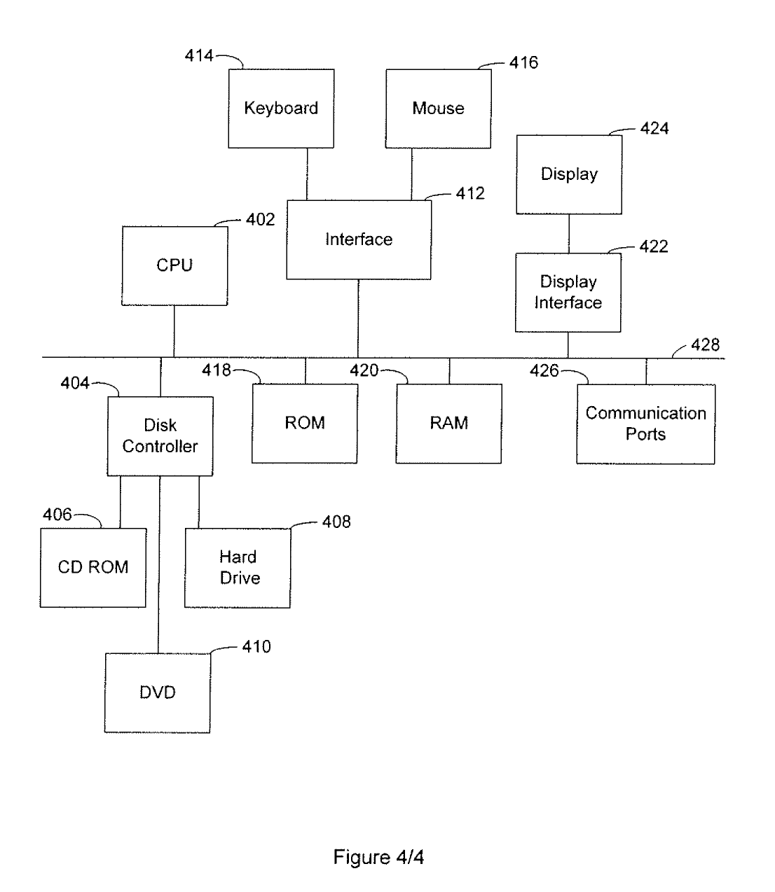

FIG. 4 depicts a block diagram of an exemplary system that may be used to contain or implement program instructions according to an embodiment. Referring to FIG. 4, a bus 428 serves as the main information highway interconnecting the other illustrated components of the hardware. CPU 402 is the central processing unit of the system, performing calculations and logic operations required to execute a program. Read only memory (ROM) 418 and random access memory (RAM) 420 constitute exemplary memory devices or storage media.

A disk controller 404 interfaces with one or more optional disk drives to the system bus 428. These disk drives may include, for example, external or internal DVD drives 410, CD ROM drives 406 or hard drives 408. As indicated previously, these various disk drives and disk controllers are optional devices.

Program instructions may be stored in the ROM 418 and/or the RAM 420. Optionally, program instructions may be stored on a computer readable storage medium, such as a hard drive, a compact disk, a digital disk, a memory or any other tangible recording medium.

An optional display interface 422 may permit information from the bus 428 to be displayed on the display 424 in audio, graphic or alphanumeric format. Communication with external devices may occur using various communication ports 426.

In addition to the standard computer-type components, the hardware may also include an interface 412 which allows for receipt of data from input devices such as a keyboard 414 or other input device 416 such as a mouse, remote control, pointer and/or joystick.

Although the disclosure contained herein describes the applicability of a lifetime warranty on a personal residence, in some embodiments, the methods and systems described herein may be used in connection with the sale of other newly constructed structures, such as commercial structures. Thus, the term “home” as used herein may include other newly constructed buildings.

What is claimed is:

1. A method of selling a home comprising:
entering into a contract with a buyer to sell a newly constructed home to the buyer; and
entering into a warranty agreement with the buyer, wherein the warranty agreement:
warrants a majority of the components of the newly constructed home for a time period of at least 25 years from the date of the contract;
requires the buyer to comply with a maintenance schedule to be verified by periodic inspection; and
conditions at least a portion of the warranty on the buyer's compliance with the maintenance schedule.

2. The method of claim 1, wherein the warranty agreement includes a term requiring the buyer to obtain pre-approval for listed modifications to the home, and failure by the buyer to obtain the pre-approval for any of the listed modifications will void at least a portion of the warranty's coverage.

3. The method of claim 1, wherein the warranty includes a term requiring the buyer to use a designated warranty service provider for listed repairs of certain components of the home, and failure by the buyer to use the designated warranty service provider for any of the listed repairs will void the warranty.

4. The method of claim 1, further comprising collecting a transaction cost from the buyer, the transaction cost comprising a cost for the home and a cost for the warranty.

5. The method of claim 1, further comprising:
constructing the home with a durable material; and
contracting with a supplier of the durable material to provide a warranty having a duration that equals or exceeds the period of the home warranty agreement.

6. The method of claim 1, further comprising automatically determining a warranty cost by using a computing device to:
access a database of projected maintenance costs for a plurality of home values, wherein each cost in the database is associated with a plurality of home specifications;
compare a plurality of specifications for the newly constructed home to the specifications in the database to determine a total projected maintenance cost over the time period; and
establish the warranty cost based on the total projected maintenance cost.

7. The method of claim 6, wherein establishing the warranty cost comprises multiplying the total projected maintenance cost by a predetermined scaling factor.

8. The method of claim 6, further comprising:
receiving the warranty cost from the buyer; and
placing the warranty cost in a reserve account.

9. The method of claim 1, further comprising:
receiving a service call from the buyer, wherein the service call requests service on a component of the home;
accessing a database of component warranties to determine whether the component is the subject of a warranty from a third party supplier warranty; and
if the component is the subject of a warranty from a third party supplier, directing the supplier to provide a service corresponding to the service call.

10. The method of claim 1, further comprising:
receiving a service call from the buyer, wherein the service call requests service on a component of the home;
determining whether the component is the subject of a warranty from a third party supplier warranty; and
if the component is not the subject of a warranty from a third party supplier, performing a service corresponding to the service call.

11. The method of claim 8, further comprising:
receiving a service call from the buyer, wherein the service call requests service on a component of the home;
determining whether the component is the subject of a warranty from a third party supplier warranty;
if the component is not the subject of a warranty from a third party supplier, performing a service corresponding to the service call, and receiving a payment for the service from the reserve account.

12. A method of selling a home comprising:
accessing a database of projected maintenance costs for a plurality of home values, wherein each cost in the database is associated with a plurality of home specifications;
comparing a plurality of specifications for a newly constructed home to the specifications in the database to determine a total projected maintenance cost over the time period;
establishing a warranty cost based on the total projected maintenance cost;
entering into a contract with a buyer to sell the newly constructed home to the buyer; and
entering into a warranty agreement with the buyer, wherein the warranty agreement:
warrants a plurality of the components of the newly constructed home for a time period;
requires the buyer to comply with a maintenance schedule to be verified by periodic inspection; and
conditions at least a portion of the warranty on the buyer's compliance with the maintenance schedule; and
collecting a transaction cost from the buyer, the transaction cost comprising a cost for the home and the warranty cost.

13. The method of claim 12, wherein the warranty agreement includes a term requiring the buyer to obtain pre-approval for listed modifications to the home, and failure by the buyer to obtain the pre-approval for any of the listed modifications will void at least a portion of the warranty's coverage.

14. The method of claim 12, wherein the warranty includes a term requiring the buyer to use a designated warranty service provider for listed repairs of certain components of the home, and failure by the buyer to use the designated warranty service provider for any of the listed repairs will void the warranty.

15. The method of claim 12, further comprising:
constructing the home with a durable material; and
contracting with a supplier of the durable material to provide a warranty having a duration that equals or exceeds the period of the home warranty agreement.

16. The method of claim 12, wherein establishing the warranty cost comprises multiplying the total projected maintenance cost by a predetermined scaling factor.

17. The method of claim 12, further comprising:
receiving a service call from the buyer, wherein the service call requests service on a component of the home;
accessing a database of component warranties to determine whether the component is the subject of a warranty from a third party supplier warranty; and
if the component is the subject of a warranty from a third party supplier, directing the supplier to provide a service corresponding to the service call.

18. The method of claim 12, further comprising:
receiving a service call from the buyer, wherein the service call requests service on a component of the home;
determining whether the component is the subject of a warranty from a third party supplier warranty; and
if the component is not the subject of a warranty from a third party supplier, performing a service corresponding to the service call.

19. The method of claim 12, further comprising:
receiving a service call from the buyer, wherein the service call requests service on a component of the home;
determining whether the component is the subject of a warranty from a third party supplier warranty;
if the component is not the subject of a warranty from a third party supplier, performing a service corresponding to the service call, and receiving a payment for the service from the collected transaction cost.
